(19) United States
(12) Patent Application Publication
(10) Pub. No.: US 2026/0168913 A1
(43) Pub. Date: Jun. 18, 2026

(54) DEVICE AND METHOD FOR SIMULATING COUPLING EFFECT OF SOIL PRESSURE AND ION CORROSION IN UNDERGROUND ENVIRONMENT

(71) Applicant: QINGDAO UNIVERSITY OF TECHNOLOGY, Qingdao (CN)

(72) Inventors: Yanru WANG, Qingdao (CN); Yubin CAO, Qingdao (CN); Shaochen ZHANG, Qingdao (CN); Jiuwen BAO, Qingdao (CN); Ran LI, Qingdao (CN); Chuansheng XIONG, Qingdao (CN)

(21) Appl. No.: 19/422,633

(22) Filed: Dec. 17, 2025

(30) Foreign Application Priority Data
Dec. 18, 2024 (CN) 2024118727230

(51) Int. Cl. G01N 17/00

(52) U.S. Cl. CPC G01N 17/002

(57) ABSTRACT

A device for simulating coupling effect of soil pressure and ion corrosion in an underground environment, may include a test chamber, the test chamber includes two semicircular pressure-transfer plates, an upper cover plate, and a lower cover plate; the upper and lower cover plates are mounted at both ends of the semicircular pressure-transfer plates, respectively, and the test chamber is further externally provided with a test frame; a plurality of pressure rods are mounted between the pressure-transfer plates and the test frame; the corrosive ion injection system includes a spiral pipeline arranged around the test block, and a plurality of micropores is uniformly distributed on a wall of the spiral pipeline; data acquisition elements in a data monitoring system are arranged in soil and connected to a data collection device, and the data collection device records and transmits data to a computer terminal.

### CROSS-REFERENCE TO RELATED APPLICATIONS

This patent application claims the priority of Chinese Patent Application No. 202411872723.0, filed to the China National Intellectual Property Administration on Dec. 18, 2024, and entitled “DEVICE FOR SIMULATING UNDERGROUND ENVIRONMENT BASED ON SOIL PRESSURE AND ION CORROSION AND OPERATING METHOD THEREOF”, the entire content of which is incorporated by reference in the present application to constitute a part of the present invention for all objectives.

### TECHNICAL FIELD

The present invention belongs to the field of simulation of underground service environments, and specifically relates to a device and method for simulating a coupling effect of soil pressure and ion corrosion in an underground environment.

### BACKGROUND

The statements in this section merely provide information of the background art correlated to the present invention and do not necessarily constitute the prior art.

At present, underground structures such as pipelines and pile foundations in complex underground environment (e.g., coastal areas) are subjected to the combined long-term effects of soil pressure and various erosive agents, leading to the continuous deterioration of their material and structural performance. With the change of environment, the species and concentration of corrosive ions (such as SO₄²⁻, Cl⁻, etc.) in soil tend to increase, especially in acidic, salt-alkaline or high moisture content soil layers, ion migration and soil pressure accelerate material degradation, causing severe consequences such as pipeline corrosion perforation, concrete spalling and structural failure.

On the other hand, major engineering projects such as energy pipelines, submarine tunnels and deep underground energy storage facilities are gradually expanding into extreme environments like the deep sea and deep geological formations. These engineering structures must operate over long periods in geological settings characterized by multi-field coupling of high pressure, high permeability and strong chemical corrosivity, facing unprecedented severe challenges to their integrity and durability. In deep-sea high-pressure sediment layers or deep high-stress rock and soil formations, structures are exposed not only to far greater hydrostatic and confining pressure than under conventional conditions, but also to continuous migration, infiltration and chemical attack from groundwater or pore fluid rich in corrosive ions (such as Cl⁻, SO₄²⁻, Mg²⁺, etc.). The long-term synergistic interaction between the pressure field and chemical field greatly accelerates the microstructural damage and materials degradation, which may lead to sudden failures and seriously compromise engineering safety and life-cycle reliability.

Under actual service conditions, material degradation results from the coupled effects of mechanical factors (such as soil pressure) and environmental chemical factors (such as ion erosion); however, the existing durability test devices and evaluation methods for underground structures and pipelines are mainly designed for shallow or single-factor environments, which cannot simulate the dynamic process of stress-seepage-chemical multi-field coupling in deep geological environments, and it is even more difficult to reproduce the synergistic corrosion mechanism of abnormal load and ion transport; and, there are some problems such as lack of integrated test system which can apply soil pressure and controllable chemical erosion synchronously and accurately, difficulty in realizing uniform and stable diffusion of erosion ions in the experiment, failure to comprehensively consider the dynamic influence of soil compactness change on pressure distribution, material stress state and erosion environment evolution, etc. This leads to a serious disconnect between traditional test data and engineering practice, which has become a key bottleneck restricting the research and development and safety evaluation of deep sea and underground engineering materials.

### SUMMARY

To address the aforementioned technical shortcomings, the present invention provides a device and method for simulating a coupling effect of soil pressure and ion corrosion in an underground environment, which can dynamically adapt to soil pressure, uniformly control ion distribution, and ensure long-term sealing performance. The experimental simulation device is capable of simultaneously applying the action of soil pressure and corrosive ions, and can authentically reproduce the combined multifactorial influences that materials experience in actual underground service conditions.

In order to achieve the aforementioned objective, the present invention is achieved through the following technical solutions.

In a first aspect, the present invention provides a device for simulating a coupling effect of soil pressure and ion corrosion in an underground environment, including: a test chamber, a loading system, a data monitoring system, and a corrosive ion injection system; wherein
the test chamber includes two semicircular pressure-transfer plates, an upper cover plate, and a lower cover plate; wherein, the two semicircular pressure-transfer plates form a cylindrical structure; the test chamber is internally configured to fill with a test block and soil; the upper cover plate is arranged at upper ends of the semicircular pressure-transfer plates and the lower cover plate is arranged at lower ends of the semicircular pressure-transfer plates; a test frame is arranged outside the test chamber; the loading system includes a plurality of pressure rods arranged between the pressure-transfer plates and the test frame; the corrosive ion injection system includes a spiral pipeline arranged around the test block; a plurality of micropores is uniformly distributed on a wall of the spiral pipeline, and each of the plurality of micropores on the wall of the spiral pipeline is provided with a filtering unit; and
the data monitoring system includes a plurality of data acquisition elements and a data collection device, the plurality of the data acquisition elements is mounted in the soil and connected to the data collection device, and the data collection device is configured to record and transmit acquisition data to a computer terminal.

Further, the two semicircular pressure-transfer plates are fabricated from steel plates of semicircular shape, the upper and lower cover plates are fabricated from steel plate; and the two semicircular pressure-transfer plates are connected to each other by a mortise-and-tenon joint structure.

Further, a sealing system is provided within the test chamber, and the sealing system includes baffles and sealing strips, wherein a plurality of insert plates is provided on each of the baffles and is configured to be embedded into a mortise-and-tenon joint between the two semicircular pressure-transfer plates, the sealing strips are arranged between the upper cover plate and the two semicircular pressure-transfer plates and between the lower cover plate and the two semicircular pressure-transfer plates.

Further, the pressure rods are uniformly distributed on the two semicircular pressure-transfer plates; a first end of each of the pressure rods is connected to an outer side of each of the two semicircular pressure-transfer plates, and a second end of the each of the pressure rods is fixedly connected to the test frame.

Further, numbers of the plurality of pressure rods arranged on the each of the two semicircular pressure-transfer plates are same.

Further, the spiral pipeline is fabricated from a corrosion-resistant material.

Further, a preset distance is provided between the spiral pipeline and the test block.

Further, the plurality of the data acquisition elements include a pressure sensor, a temperature-humidity sensor, a pH value tester, and an ion concentration detector, and are configured to real-timely monitor a pressure change, a soil condition, and an ion concentration distribution in the test chamber.

Further, the two semicircular pressure-transfer plates and the baffles in the simulation device are fabricated from corrosion resistant materials.

In a second aspect, the present invention further provides a method for simulating a coupling effect of soil pressure and ion corrosion in an underground environment, including:
S1, placing a test block at a designated position inside a test chamber, then filling the test chamber with soil to ensure that the test block is completely surrounded by the soil, as well as maintaining a preset distance between a spiral pipeline and the test block;
S2, applying a force to pressure rods by hydraulic or mechanical means, so as to generate a pressure inside the test chamber by the pressure rods; wherein, numbers of the pressure rods arranged at two pressure-transfer plates are same, such that the pressure is uniformly distributed inside the test chamber by a multi-point loading means;
S3, injecting a prepared corrosive ion solution into the spiral pipeline, and allowing the solution to be evenly released into the soil through micropores uniformly distributed on the wall of the spiral pipeline and diffuse onto a surface of the test block;
S4, throughout a test procedure, a pressure sensor, a temperature-humidity sensor, a pH value tester, and an ion concentration detector mounted within the test chamber real-timely monitor data on a pressure change, a soil condition, and an ion concentration distribution, and transmit the monitoring data to a computer terminal via a data collection device; and
S5, upon completion of the test, analyzing dynamic changes during the test procedure; and, cleaning and maintaining the device for reusing.

Compared with the prior art, the beneficial advantages and positive effects of the present invention are as follows:

According to the present invention, the test chamber is internally filled with the test block and soil, which can simulate the stress and corrosion mechanisms of the pipeline in actual underground environment. By reasonably configuring the distance between the spiral pipeline and the test block, injecting the corrosive ion solution, and other operations, the diffusion path and corrosion mechanism of ions in underground environment can be better simulated. The pressure-transfer plates of the test chamber are formed by two spliced plates, which can adapt to the changes of soil from loose to compact, ensuring the effective transfer of loading force. The spiral pipeline of the corrosive ion injection system is fabricated from corrosion-resistant materials, and the micropores on the wall of the spiral pipeline are equipped with filtering units to prevent soil particles from blocking the pipeline and causing experimental errors. The spiral structure of the pipeline design can ensure uniform ion distribution and prevents local ion concentration accumulation, and can accurately simulate the concentration distribution of corrosive ions in underground environment. The data monitoring system can real-timely monitor pressure changes, soil conditions, and ion concentration distribution, and transmit data to the computer terminal for the convenient analysis on the dynamic changes during the test procedure.

According to the present invention, the pressure-transfer plates of the test chamber are connected by a mortise-and-tenon joint structure, with the tenons and mortises embedded together, which can achieve dynamic fit under external loading to adapt to changes of soil from loose to compact. Such a configuration prevents the separation between the test chamber wall and the soil due to the soil volume reduction under sustained external loading, thereby ensuring the effective transfer of the loading force. The baffle can dynamically fill gaps caused by soil compaction, preventing the leakage of soil particles. Additionally, flexible sealing strips are mounted at the edges of the upper and lower cover plates to prevent soil leakage caused by changes in diameter of the cover plates, thus ensuring the integrity of the test environment. The pressure rods are uniformly distributed on the pressure-transfer plates, with an equal number of the pressure rods on each plate. Force is applied hydraulically or mechanically such that multi-point loading enables uniform pressure distribution within the test chamber, thus avoiding the concentration of the loading force. The mortise and tenon joint structure of the pressure-transfer plates will always remain in close fit to the soil as soil volume changes, which ensures that the loading force can be transferred to the interior of the soil effectively, thereby simulating the actual underground pressure environment.

### BRIEF DESCRIPTION OF THE DRAWINGS

The accompanying drawings of the description which constitute a part of the present invention are used for providing a further understanding of the present invention. The illustrative embodiments of the present invention and the specification thereof are used for interpreting the present invention, but do not constitute an improper limitation to the present invention.

FIG. 1 shows an overall structure of a device for simulating a coupling effect of soil pressure and ion corrosion in an underground environment according to the present invention.

FIG. 2 shows an external structure of a test chamber according to the present invention.

FIG. 3 shows an internal structure of the test chamber according to the present invention.

FIG. 4 shows a test block, data acquisition elements, a data collection device, and a computer terminal according to the present invention.

In the drawings: 1, test chamber; 2, pressure rod; 3, test frame; 4, pressure-transfer plate; 5, upper cover plate; 6, lower cover plate; 7, sealing strip; 8, insert plate; 9, baffle; 10, spiral pipeline.

### DETAILED DESCRIPTION

It should be indicated that the following detailed descriptions are all exemplary and are intended to provide further illustration of the present invention. Unless otherwise specified, all the technical and scientific terms used in the present invention have the same meanings as those commonly understood by those skilled in the art to which the present invention belongs.

It should be noted that the terms used herein are merely for describing detailed embodiments but are not intended to limit the exemplary embodiments according to the present invention. As used herein, unless otherwise explicitly indicated in the present invention, the singular form is also intended to include its plural form. In addition, it should be understood that when the terms “comprise/comprising” and/or “include/including” are used in the description, they indicate the presence of features, steps, operations, devices, components and/or combinations thereof.

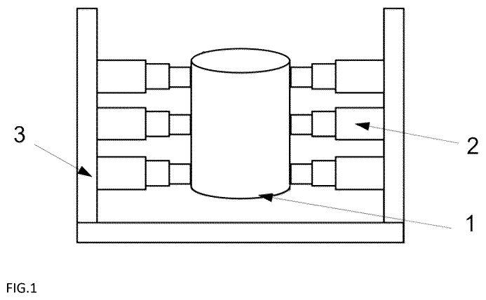

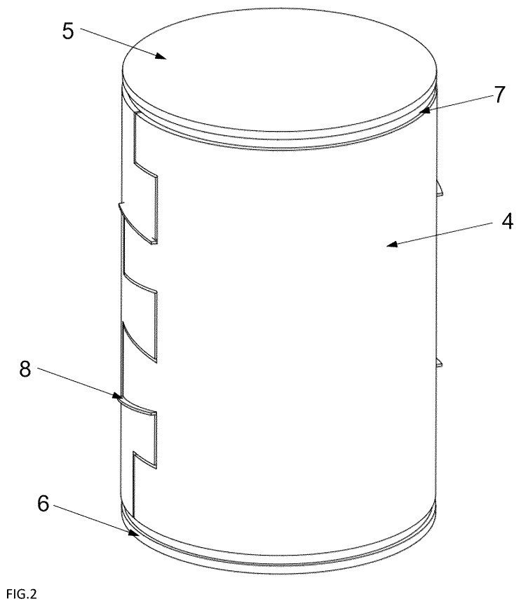

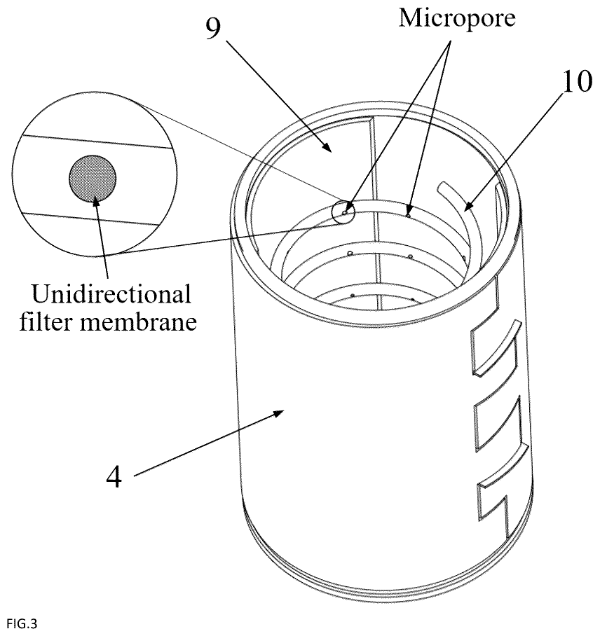

The present example discloses a device for simulating a coupling effect of soil pressure and ion corrosion in an underground environment, as shown in FIGS. 1-4, includes a test chamber 1, a loading system, a data monitoring system, a corrosive ion injection system, and a sealing system; wherein, the test chamber 1 includes two semicircular pressure-transfer plates 4, an upper cover plate 5, and a lower cover plate 6; the two semicircular pressure-transfer plates 4 form a cylindrical structure; the test chamber is internally configured to fill with a test block and soil; the upper cover plate 5 is arranged a top end of the semicircular pressure-transfer plates 4, and the lower cover plate 6 is arranged at a lower end of the semicircular pressure-transfer plates 4; a U-shaped test frame 3 is further arranged outside the test chamber 1; the loading system includes a plurality of pressure rods 2 uniformly distributed on peripheries of the two semicircular pressure-transfer plates 4; a first end of each pressure rod 2 is connected to the exterior of each pressure-transfer plate 4; the corrosive ion injection system includes a spiral pipeline 10, and a plurality of micropores is uniformly distributed on a wall of the spiral pipeline 10; the device further includes a data monitoring system, the data monitoring system includes data acquisition elements and a data collection device; the data acquisition elements are mounted within the soil and connected to the data collection device, and the data collection device records and transmits data to a computer terminal.

The test chamber 1 is designed as a cylinder, and is internally configured to fill with a test block and soil, thereby achieving the real simulation of the pipeline stress and corrosion mechanism in underground environment. The pressure-transfer plates 4 of the test chamber 1 are fabricated from two semicircular steel plates, and the upper cover plate 5 and lower cover plate 6 are fabricated from flat steel plates. The two pressure-transfer plates 4 are connected by a mortise and tenon joint structure, with the tenons and the mortises embedded together, enabling dynamic fit under external loading to adapt to the process of soil changing from loose to compact. Such a configuration solves the problem of separation between the test chamber wall and soil caused by the soil volume reduction under sustained external loading, thereby ensuring the effective transfer of the loading force.

The sealing system includes two baffles 9 and two sealing strips 7. Each baffle 9 is provided with an insert plate 8 embedded between the tenons and mortises of the pressure-transfer plates 4. The two sealing strips 7 are arranged among the upper cover plate 5, the lower cover plate 6, and the two semicircular pressure-transfer plates 4, respectively. The baffles 9 having a T-shape are configured to dynamically fill gaps caused by soil compaction, thus preventing the leakage of soil particles, and enhancing the long-term sealing performance of the device. Meanwhile, flexible sealing strips 7 are arranged at the edges of the upper cover plate 5 and lower cover plate 6 to enhance the sealing performance and prevent soil leakage caused by the changes in diameter of the cover plates, thereby effectively ensuring the integrity of the test environment.

The pressure rods 2 are uniformly distributed on the peripheries of the pressure-transfer plates 4; the first end of the each pressure rod 2 is connected to the outer side of the each pressure-transfer plate 4, and a second end of the each pressure rod 2 is fixedly connected to the test frame 3. Numbers of the pressure rods 2 are uniformly arranged on the outer sides of both pressure-transfer plates 4 are more than one and are same. Uniform pressure is applied to the pressure plates by hydraulic or mechanical means, and multi-point loading ensures uniform pressure distribution within the test chamber remains throughout the test procedure, thereby avoiding the concentration of the loading force. Similarly, the mortise and tenon joint structure of the pressure-transfer plates 4 always remains in close contact with the soil as soil volume changes, which ensures that the loading force may be effectively transferred to the interior of the soil to simulate the actual underground pressure environment.

The spiral pipeline 10 of the corrosive ion injection system is arranged around the test block, fabricated from corrosion-resistant materials, and has a plurality of micropores uniformly distributed on the wall of the spiral pipeline. Each micropore on the wall of the spiral pipeline 10 is equipped with a filtering unit to prevent soil particles from blocking the pipeline and causing artificial test errors. Corrosive ion solution is injected via the spiral pipeline 10, and is uniformly released into the soil through the micropores and diffused to the surface of the test block, thereby simulating the concentration distribution of corrosive ions in underground environment. The spiral structure of pipeline design ensures uniform ion distribution, prevents local accumulation of ion concentration, thereby ensuring the reliability and authenticity of the test results.

In the present example, the filtering unit may adopt a filtering membrane, and the filtering membrane may be a unidirectional filtering membrane, so that corrosive ions can enter a soil side through the unidirectional filtering membrane from the inner side of the spiral pipeline, and simultaneously prevent soil particles or other substance particles in the soil from entering the spiral pipeline from the soil side, and prevent the soil particles from blocking the micropores.

The interior of the cylindrical test chamber is configured to fill with the test block and soil, the test block is completely surrounded by the soil. A preset distance is maintained between the spiral pipeline 10 and the test block to simulate the ion diffusion path and corrosion mechanism in the underground environment.

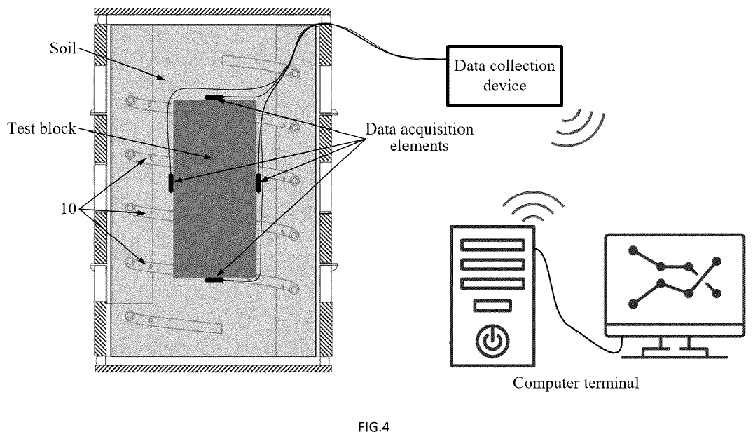

The device is equipped with a data monitoring system, as shown in FIG. 4, the data monitoring system includes a pressure sensor, a temperature-humidity sensor, a pH value tester, and an ion concentration detector, and is configured to real-timely monitor the pressure changes, soil conditions, and ion concentration distribution. The pressure sensor, the temperature-humidity sensor, the pH value tester, and the ion concentration detector are mounted within the test chamber 1 and are all connected to the data collection device. The data collection device records and transmits the data to a computer terminal, thus facilitating the analysis on the dynamic changes during the test procedure.

Preferably, but not limited thereto, the pressure-transfer plates 4 and the baffles 9 in the device are both fabricated from corrosion-resistant materials, e.g., a stainless steel or a polyethylene protective layer is configured. A main body of the test chamber of the device is designed as a detachable structure, facilitating cleaning, maintenance, and reuse of the device, thereby improving the economic efficiency and applicability of the test.

A method for simulating a coupling effect of soil pressure and ion corrosion in an underground environment of the present invention, mainly includes the following steps:
S1, placing a test block at a designated position inside a test chamber 1, then filling the test chamber with soil to ensure that the test block is completely surrounded by the soil, as well as maintaining a preset distance between a spiral pipeline 10 and the test block.
S2, applying a force to pressure rods 2 by hydraulic or mechanical means; the pressure rods 2 are evenly distributed between the test chamber 1 and a test frame 3 and with same number on each pressure-transfer plate 4, wherein a first end of each pressure rod is connected to an exterior of each pressure-transfer plate 4 and a second end of each pressure rod is fixedly connected to the test frame 3. Hence, multi-point loading is provided to ensure uniform pressure distribution within the test chamber, thus preventing concentration of the loading force.
S3, injecting a prepared corrosive ion solution into the spiral pipeline 10 such that the solution is evenly released into the soil through micropores uniformly distributed on a wall of the spiral pipeline and diffused onto a surface of the test block. The spiral structure of the pipeline may ensure uniform ion distribution and avoid the local accumulation of ion concentration, thereby simulating the concentration distribution of corrosive ions in the underground environment.
S4, throughout the test procedure, real-timely monitoring, by the pressure sensor, the temperature-humidity sensor, the pH value tester, and the ion concentration detector arranged within the test chamber 1, data on pressure changes, soil conditions, and ion concentration distribution, and transmitting the monitoring data to a computer terminal via a data collection device, for the convenience of the follow-up operation.
S5, upon completion of the test, performing an analysis on the dynamic changes during the test procedure; and, cleaning and maintaining the device for reusing. The pressure-transfer plates 4 and the baffles 9 are fabricated from corrosion-resistant materials, which may ensure the subsequent performance of the equipment in use and improve the economic efficiency and applicability of the experiment better.

The detailed examples of the present invention have been described in combination with the drawings, but are not construed as limiting the scope of protection of the present invention. Those skilled in the art should understand that, based on the technical solutions of the present invention, various amendments or transformations made by those skilled in the art without any inventive efforts shall still fall within the scope of protection of the present invention.

1. A device for simulating underground environment based on soil pressure and ion corrosion, comprising:
a test chamber,
a loading system,
a data monitoring system,
a sealing system, and
a corrosive ion injection system; wherein,
the test chamber comprises two semicircular pressure-transfer plates, an upper cover plate, and a lower cover plate; the two semicircular pressure-transfer plates form a cylindrical structure, and the test chamber is internally configured to fill with a test block and soil; the upper cover plate and the lower cover plate are provided at both ends of the semicircular pressure-transfer plates, respectively; the test chamber is further externally provided with a test frame; the pressure-transfer plates of the test chamber are fabricated from two semicircular steel plates; the upper cover plate and the lower cover plate are fabricated from steel plates; and, the two pressure-transfer plates are connected by using a mortise and tenon joint structure;
the loading system comprises a plurality of pressure rods that are provided between the pressure-transfer plates and the test frame; the pressure rods are uniformly distributed on the pressure-transfer plates, one end of each of the pressure rods is connected to an outer side of each of the pressure-transfer plates, and the other end of the each of the pressure rods is fixedly connected to the test frame;
the sealing system comprises baffles and sealing strips, the baffles are provided with an insert plate embedded between tenons and mortises of the two pressure-transfer plates, and the sealing strips are provided between the upper cover plate, the lower cover plate, and the two semicircular pressure-transfer plates;
the corrosive ion injection system comprises a spiral pipeline arranged around the test block, a plurality of micropores are uniformly distributed on a wall of the spiral pipeline, and each of the micropores on the wall of the spiral pipeline is provided with a filtering unit; and
the data monitoring system comprises data acquisition elements and a data collection device, the data acquisition elements are provided in the soil and connected to the data collection device, and the data collection device is configured to record and transmit data to a computer terminal.

2. The device for simulating underground environment based on soil pressure and ion corrosion according to claim 1, wherein the plurality of pressure rods are uniformly provided on the each of the two pressure-transfer plates, with a same number on the each of the pressure-transfer plates.

3. The device for simulating underground environment based on soil pressure and ion corrosion according to claim 2, wherein the spiral pipeline is fabricated from corrosion-resistant materials; the plurality of micropores are uniformly distributed on the wall of the spiral pipeline, and the each of the micropores on the wall of the spiral pipeline is provided with the filtering unit.

4. The device for simulating underground environment based on soil pressure and ion corrosion according to claim 3, wherein a preset distance is provided to be maintained between the spiral pipeline and the test block.

5. The device for simulating underground environment based on soil pressure and ion corrosion according to claim 4, wherein the data acquisition elements comprise a pressure sensor, a temperature-humidity sensor, a pH value tester, and an ion concentration detector, and are configured to real-timely monitor a pressure change, a soil condition, and an ion concentration distribution.

6. The device for simulating underground environment based on soil pressure and ion corrosion according to claim 5, wherein the pressure-transfer plates and the baffles in the device are all fabricated from corrosion-resistant materials.

7. An operating method of the device for simulating underground environment based on soil pressure and ion corrosion according to claim 6, comprising:
S1, placing the test block at a designated position inside the test chamber, then filling the test chamber with soil to ensure that the test block is completely surrounded by the soil; as well as maintaining a preset distance between the spiral pipeline and the test block;
S2, applying a force to the pressure rods by hydraulic or mechanical means, with the same number of the pressure rods arranged on both the two pressure-transfer plates, such that a pressure is uniform distributed within the test chamber based on a multi-point loading means;
S3, injecting a prepared corrosive ion solution into the spiral pipeline, and allowing the solution to be evenly released into the soil through the plurality of the micropores uniformly distributed on the wall of the spiral pipeline and diffuse onto a surface of the test block;
S4, throughout a test procedure, real-timely monitoring, by the pressure sensor, the temperature-humidity sensor, the pH value tester, and the ion concentration detector provided within the test chamber, data on a pressure change, a soil condition, and an ion concentration distribution, and transmitting the data to a computer terminal via the data collection device; and
S5, upon a completion of the test, performing an analysis on dynamic changes during the test procedure; and, cleaning and maintaining the device for reusing.
